(19) United States
(12) Patent Application Publication
(10) Pub. No.: US 2003/0102017 A1
(43) Pub. Date: Jun. 5, 2003

(54) Substrate processing apparatus

(76) Inventor: Hiroki Taniyama, Tosu-Shi (JP)

Correspondence Address: SMITH, GAMBRELL & RUSSELL, LLP, 1850 M STREET, N.W., SUITE 800, WASHINGTON, DC, 20036, US

(21) Appl. No.: 10/309,049

(22) Filed: Dec. 4, 2002

(30) Foreign Application Priority Data
Dec. 4, 2001 (JP) 2001-369627

(51) Int. Cl. B08B 3/00

(52) U.S. Cl. 134/100.1; 134/113; 134/198

(57) ABSTRACT

The prevent invention provides a substrate processing apparatus and a substrate processing method which can process hydrophobic wafers with a fluid mixing nozzle.

The substrate processing apparatus comprises processing liquid supply means 66 for supplying a processing liquid, inert gas supply means 67 for supplying an inert gas, and a fluid mixing nozzle 65 for mixing the processing liquid with the inert gas to eject the mixed processing liquid to the substrate, whereby the substrate is processed with the processing liquid, in which the inert gas supply means 67 comprises liquid mixing means 97b for mixing a fluid, IPA, for lowering surface tension of the processing liquid, and the inert gas.

### CROSS REFERENCE TO RELATED APPLICATIONS

The subject application is related to subject matter disclosed in Japanese Patent Application No. 2001-369627 filed on Dec. 4, 2001 to which the subject application claims priority under Paris Convention and which are incorporated herein by reference.

### BACKGROUND OF THE INVENTION

1. Field of the Invention

The present invention relates to a substrate processing apparatus for making cleaning processing, etc. on substrates, e.g., semiconductor wafers, glasses for LCD substrates, etc., and a substrate processing method.

2. Description of the Prior Art

In processes for fabricating semiconductor devices, for example, processing systems including substrate processing apparatuses for etching and/or ashing semiconductor wafers, etc (hereinafter called wafers, etc.) are used. Such processing systems include single-substrate cleaning processing apparatuses for removing polymers, particles, etc. generated on the processed surfaces of wafers after the ashing. The single-substrate cleaning processing apparatuses perform a string of cleaning processing steps of first feeding wafers a chemical liquid to make chemical liquid cleaning, then subjecting the wafers to rinse processing including particle removal with pure water, and finally rotating the wafers to scatter away the pure water or feeding a drying gas, such as IPA, N₂ gas or others to dry the wafers. A fluid mixing nozzle, which is one kind of nozzles for supplying pure water, mixes pure water with an inert gas, such as N₂ gas or others to pressurize and eject the pure water onto the processed surfaces of the wafers.

Here, when pure water is applied to highly hydrophobic wafers, a problem that water marks may be formed after drying takes place. The water marks are detected as defects by surface scanners. Especially when pure water is applied with a two-fluid supply nozzle, a number of the defects are detected. This has made it difficult to use the fluid mixing nozzle in cleaning hydrophobic wafers. In the conventional cleaning processing, the processed surfaces of wafers are often made hydrophobic depending on kinds of chemical liquids applied to the wafers for the chemical liquid cleaning, which has been a cause for generating the defects.

### SUMMARY OF THE INVENTION

An object of the present invention is to provide a substrate processing apparatus and a substrate processing method which can process hydrophobic wafers by the use of a fluid mixing nozzle.

To solve the above-described problem, the present invention provides a substrate processing apparatus comprising processing liquid supply pipe for supplying a processing liquid, inert gas supply pipe for supplying an inert gas, and a fluid mixing nozzle for mixing and ejecting the processing liquid with the inert gas, so as to process a substrate with the processing liquid, in which, the inert gas supply pipe or the processing liquid supply pipe comprising fluid mixer for mixing a fluid for lowering surface tension of the processing liquid into the inert gas or the processing liquid respectively. In this substrate processing apparatus, the processing liquid is mixed with the fluid for lowering surface tension of the processing liquid, and is supplied to wafers, whereby the generation of water marks can be depressed.

It is preferable that the substrate processing apparatus comprises a control unit for controlling a mixing ratio of the processing liquid and the fluid for lowering surface tension of the processing liquid, or the start/stop of mixing the fluid for lowering surface tension of the processing liquid into the inert gas or the processing liquid. The substrate processing apparatus may comprise a chemical liquid supply nozzle for supply a chemical liquid to the substrate. It is preferable that the control unit controls a mixing ratio of the processing liquid and the fluid for lowering surface tension of the processing liquid, or the start/stop of mixing the fluid for lowering surface tension of the processing liquid into the inert gas or the processing liquid, based on a kind of the chemical liquid. In this case, an intensity of hydrophobicity of the wafer which has been subjected to the processing with the chemical liquid can be estimated based on a kind of the chemical liquid.

The substrate processing apparatus may comprise a detector for detecting whether the substrate is hydrophobic or hydrophilic. The detector preferably drops a drop of a detection chemical liquid onto the substrate and measures a contact angle of the drop to the surface of the substrate.

Furthermore, It is preferable that the control unit controls a mixing ratio of the processing liquid and the fluid for lowering surface tension of the processing liquid, or the start/stop of mixing the fluid for lowering surface tension of the processing liquid into the inert gas or the processing liquid, based on a detection result of the detector. It is also preferable that the control unit gets information of whether the substrate is hydrophobic or hydrophilic and perform control so as to supply the processing liquid and the inert gas onto the substrate when the substrate is hydrophilic and supply the processing liquid, the inert gas and the fluid for lowering surface tension of the processing liquid onto the substrate when the substrate is hydrophobic. That is, as the wafer is more hydrophobic, it is necessary to increase a mixed amount of the fluid for lowering surface tension of the processing liquid, but when the hydrophobicity is low, the mixed amount of the fluid for lowering surface tension of the processing liquid is decreased, whereby a used amount of the fluid for lowering surface tension of the processing liquid can be made smaller. The The substrate processing apparatus may comprises input means for inputting an information of whether the substrate is hydrophobic or hydrophilic, whereby the control unit gets the information from the input means and controls a mixing ratio of the processing liquid and the fluid for lowering surface tension of the processing liquid, or the start/stop of mixing the fluid for lowering surface tension of the processing liquid into the inert gas or the processing liquid. the control unit may control a mixing ratio of the processing liquid and the fluid for lowering surface tension of the processing liquid, or the start/stop of mixing the fluid for lowering surface tension of the processing liquid into the inert gas or the processing liquid, based on a kind of a film of the substrate. The inert gas supply pipe may comprise an temperature adjuster for adjusting a temperature of the inert gas.

The present invention provides a method for mixing and supplying a processing liquid and an inert gas to process a substrate with the processing liquid, in which a mixture of the processing liquid and an inert gas mixed with a fluid for lowering surface tension of the processing liquid are supplied to the substrate. In this substrate processing method, the processing liquid is mixed with the fluid for lowering surface tension of the processing liquid and is fed to the wafer to thereby lower the surface tension of the processing liquid staying on the wafer, whereby the generation of water marks can be depressed.

The present invention provides a substrate processing method for mixing and supplying a processing liquid and an inert gas to process a substrate with the processing liquid, in which a mixture of the processing liquid mixed with a fluid for lowering surface tension of the processing liquid and the inert gas is supplied to the substrate.

The present invention provides a substrate processing method for mixing and supplying a processing liquid and an inert gas to process a substrate with the processing liquid, in which it is judged whether the substrate is hydrophobic or hydrophilic, and when the substrate is hydrophilic, the processing liquid and the inert gas are mixed to be supplied to the substrate, and when the substrate is hydrophobic, the processing liquid, a fluid for lowering surface tension of the processing liquid, and the inert gas to be supplied to the substrate.

The substrate processing method may comprise the step of supplying a chemical liquid to process the substrate before the step of processing the substrate with the processing liquid. The mixture of the fluid may be controlled based on a kind of the chemical liquid.

It is possible that a detection chemical liquid for detecting intensity of hydrophobicity of a substrate is dropped, and a contact angle of the drop to the processed surface of the substrate is metered to thereby detect whether the substrate is hydrophobic or hydrophilic. That is, when the hydrohobicity of the substrate is intense, a contact angle of the detection liquid to the processed surface of the substrate is large, whereby it can be detected whether the substrate is hydrophobic or hydrophilic. It is preferable to control the mixture of the fluid, based on a degree of the contact angle, and in this case, when the hydrohobicity is low, the fluid for lowering the surface tension of the processing liquid is mixed in a smaller amount, whereby a used amount of the fluid can be made smaller.

The substrate processing method may comprise the step of ashing the substrate, the step of supplying the chemical liquid to process the substrate, the step of drying the substrate and the step of baking the substrate.

In the present invention, it is preferable that pure water is used as the processing liquid, and IPA (isopropyl alcohol), for example, is used as the fluid for lowering the surface tension of the processing liquid.

### BRIEF DESCRIPTION OF THE DRAWINGS

FIG. 1 is a diagrammatic plan view of the processing system.

FIG. 2 is a diagrammatic sectional view of the processing system.

FIG. 3A is a view explaining a contact angle of a liquid drop at the processed surface of a wafer.

FIG. 3B is a view explaining a contact angle of a liquid drop at the processed surface of a wafer.

FIG. 4 is a plan view of the substrate processing unit according to an embodiment of the present invention.

FIG. 5 is a vertical sectional view of the substrate processing unit according to the present embodiment.

FIG. 6 is a view explaining a supply circuit for supplying pure water and N₂ gas.

FIG. 7 is a vertical sectional view of an outer chamber in the rinse processing step, which shows the inside of the outer chamber.

FIG. 8 is a view explaining a supply circuit for supplying pure water and N₂ gas of another embodiment of the present invention.

### DESCRIPTION OF PREFERRED EMBODIMENTS

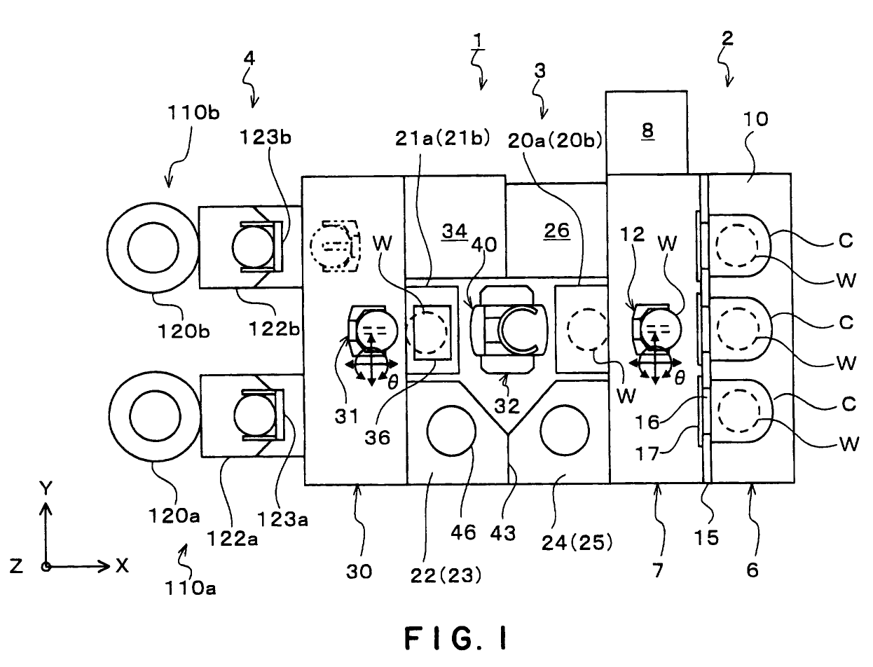

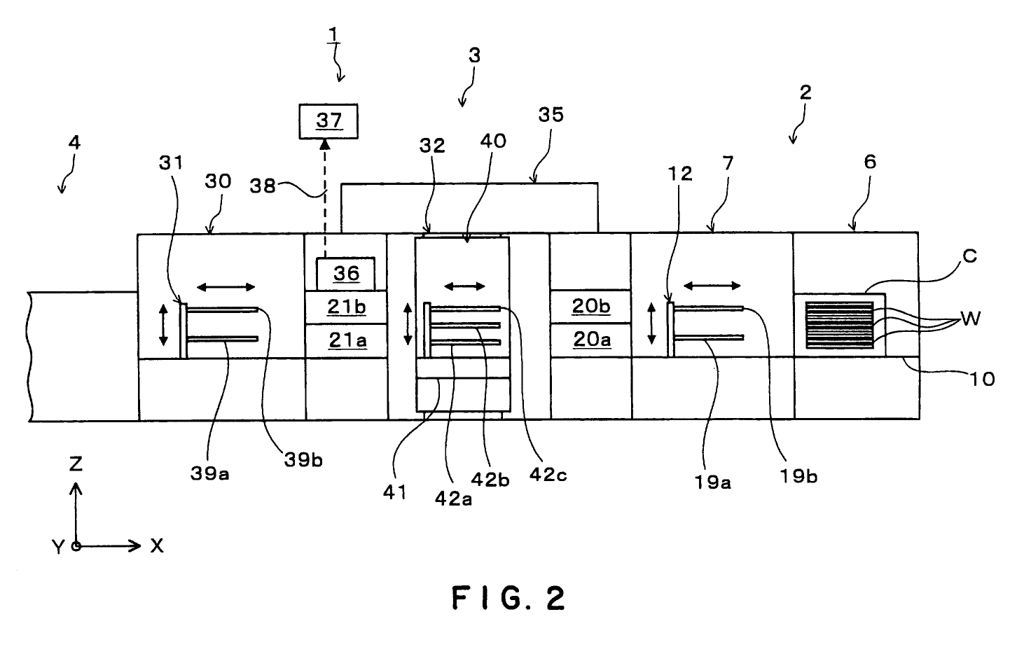

A preferred embodiment of the present invention will be explained by means of substrate processing apparatus units which are arranged to clean both surfaces of wafers as one example of substrates. FIG. 1 is a diagrammatic plan view of a processing system 1 incorporating substrate processing units 22, 23, 24, 25 which are the substrate processing apparatuses according to the present embodiment. FIG. 2 is a diagrammatic side view of the processing system 1. The processing system 1 comprises a carrying-in/out unit 2 for carrying wafers Win and out of a cleaning processing unit 3, the cleaning processing unit 3 for performing on the wafers cleaning processing and thermal processing following the cleaning processing, and an etching processing unit 4 for performing etching processing and/or ashing processing on the wafers W.

The carrying-in/out unit 2 comprises an in/out port 6 having a mount 10 for mounting containers (carriers C) each housing a plurality of wafers W, e.g., 25 wafers, substantially horizontally spaced form each other, a wafer carrier unit 7 having a wafer carrier 12 which transfers the wafers between the carriers C mounted on the mount 10 and the cleaning processing unit 3, and a line width measuring unit 8 which measures the wafers W which have completed the processing by the etching processing unit 4 and the cleaning processing unit 3, for line widths of a pattern provided on the processed surfaces of the wafers W.

In each carrier C, wafers W are loaded into the carrier C through one side. On this side, a lid which is openable and closable is provided. Shelf plates for retaining wafers W at a prescribed interval are provided on the inside wall, and 25 slots for accommodating the wafers are formed. The wafers W are set each in each slot with the front surfaces (the processed surfaces for a semiconductor device to be fabricated on) of the wafers W faced upward (when the wafers W are held horizontally).

Three, for example, carriers can be mounted on the mount 10 of the in/out port 6 in the Y direction in the horizontal plane. The carriers are mounted with the sides with the lids provided on opposed to the bordering wall 15 between the in/out port 6 and the wafer carrier unit 7. Window opening/closing mechanisms 17 for opening and closing the windows 16 with shutters or others are provided on the side of the windows 16 opposed to the wafer carrier unit 7.

The window opening/closing mechanisms 17 open and close the lids, which is provided on the Carrier C and is also openable and closable, concurrently with opening and closing the windows 16. It is preferable to interlock the window opening/closing mechanisms 17 not to operate when the carriers C are not mounted on the mount at prescribed positions. When the windows 16 are opened, and the wafer load in/out openings of the carriers C and the wafer carrier unit 7 are brought into communication, the wafer carrier 12 disposed in the wafer carrier unit 7 can approach the carriers C, and the wafer carrier 12 can carry the wafers W. Wafer detectors not shown are disposed above the windows 16 so that numbers of wafers W housed in the carriers C, and states of the wafers W per each slot can be detected. Such wafer detectors can be mounted on the window opening/closing mechanisms 17.

The wafer carrier 12 disposed in the wafer carrying unit 7 can move in the Y direction and the Z direction and is rotatable in the X-Y plane (θ direction). The wafer carrier 7 has two take-out/setting arms 19a, 19b for holding a wafer W, and the take-out/setting arms 19a, 19b are slidable in the X-Y plane and are movable forward and backward independently from each other. Thus, the wafer carrier 12 approaches the slots at arbitrary heights of all the carriers C mounted on the mount 10 and approaches two wafer transfer units (TRS) 20a, 20b disposed vertically in the cleaning processing unit 3 to thereby carry the wafers W from the in/out port 6 to the cleaning processing unit 3 and oppositely from the cleaning processing unit 3 to the in/out port 6. The wafer carrier 12 can carry the wafers W which have been subjected to the processing in the etching processing unit 4 and the cleaning processing unit 3 from the wafer transfer units (TRS) 20a, 20b to the line width measuring unit 8 and can carry the wafers W which have been subjected to the detection by the line width measuring unit 8 to the in/out port 6.

The cleaning processing unit 3 comprises the wafer transfer units (TRS) 20a, 20b for temporarily mounting wafers W to transfer the wafers W to and from the wafer carrying unit 7, wafer transfer units (TRS) 21a, 21b for temporarily mounting wafers W to transfer the wafers W to and from the etching processing unit 4, four substrate processing units 22, 23, 24, 25 according to the present embodiment, and a heating/cooling unit 26 including, e.g., five stacked baking units for heating wafers W which have been subjected to the cleaning processing, and a cooling unit for cooling the heated wafers W. The cleaning processing unit 3 includes a wafer carrying unit 30 comprising wafer carrier 31 which transfers wafers between the etching processing unit 4 and the wafer transfer units 21a, 21b, and a primary wafer carrier 32. The primary wafer carrier 32 is arranged to approach the wafer transfer units 20a, 20b, 21a, 21b, the substrate processing units 22, 23, 24, 25, and the baking units and the cooling unit of the heating/cooling unit 26.

A maintenance area 34 is provided in the cleaning processing unit 3 for maintaining the wafer transfer units 20a, 20b, 21a, 21b and the substrate processing units 22, 23, 24, 25, and the baking units and the cooling unit of the heating/cooling unit 26, which facilitates the maintenance. On the ceiling of the cleaning unit 3, a fan filter unit (FFU) 35 is disposed, for down-flowing pure air to the respective units and the primary wafer carrier 32.

The wafer transfer units 20a, 20b are vertically stacked in two stages. For example, the lower wafer transfer unit 20a is used to mount a wafer W which is carried from the in/out port 6 to the cleaning processing unit 3, and the upper wafer transfer unit 20b is used to mount a wafer W which is carried from the cleaning processing unit 3 to the in/out port 6.

The wafer transfer units 21a, 21b are vertically stacked in two stages. For example, the lower wafer transfer unit 21a can be used to mount a wafer W which is carried from the cleaning processing unit 3 to the etching processing unit 4, and the upper wafer transfer unit 21b can be used to mount a wafer W which is carried form the etching processing unit 4 to the cleaning processing unit 3. A detector 36 which detects whether a wafer is hydrophobic or hydrophilic is disposed above the upper wafer transfer unit 21b.

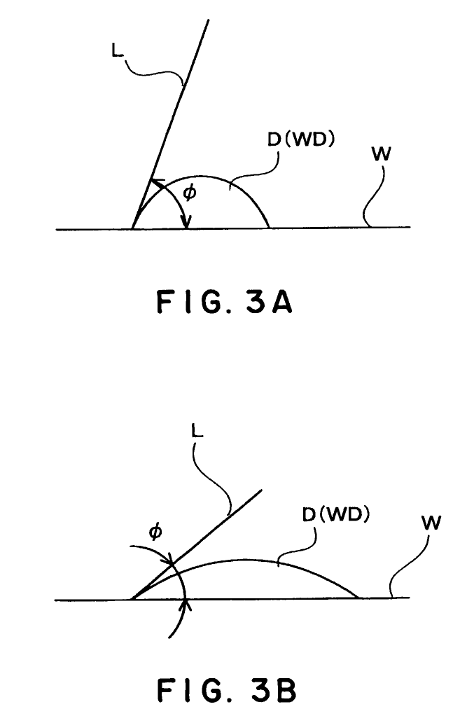

The detector 36 drops a detection chemical liquid for detecting intensity of phydrophobicity of a wafer W to measure a contact angle φ of the drop D on the processed surface of the wafer W. FIGS. 3A and 3B show the processed surfaces of wafers W with liquid drops D applied to. The contact angles φ are angles formed by the processed surfaces of wafers W and tangents L of the drops D at the processed surfaces. When a wafer W has intense phydrophbicity, as shown in FIG. 3A, the contact angle φis large, but the contact angle φ is small as shown in FIG. 3B when a wafer W has weak phydrophobicity. Thus, a contact angle φ to the processed surface of a wafer W is measured to thereby meter intensity of the phydrophobicity of the wafer W. The detector 36 is connected to a control unit 37 by a signal line 38, so that the metered intensity of the phydrophobicity is supplied as detected signals to the control unit 37. The control unit 37 can judge whether the wafer W is phydrophobic or hydrophilic. When wafers W are loaded into the substrate processing units 22, 23, 24, 25, the wafers W are mounted on the wafer transfer unit 21a before loaded to detect the phydrophobicity of the processed surfaces of the wafers W.

Part of the down-blow from the fan filter unit (FFU) 35 passes through the wafer transfer units 20a, 20b, and a space above the wafer transfer units 20a. 20b to flow toward the wafer carrying unit 7. This prohibits the intrusion of particles, etc. from the wafer carrying unit 7 into the cleaning processing unit 3 to thereby keep cleanliness of the cleaning processing unit 3. Part of the down-blow from the fan filter unit (FFU) 35 passes through the wafer transfer units 21a, 21b, and a space above the wafer transfer units 21a. 21b to flow toward the wafer carrying unit 30. This prohibits the intrusion of particles, etc. from the wafer carrying unit 30 into the cleaning processing unit 3 to thereby retain cleanliness of the cleaning processing unit 3.

The wafer carrier 31 disposed in the wafer carrying unit 30 is movable in the Y-direction and the Z-direction and is rotatable in the X-Y plane (θ direction). The wafer carrier 31 has two take-out/setting arms 39a, 39b for holding a wafer W, and the take-out/setting arms 39a, 39b are slidable in the X-direction and are movable forward and backward independently form each other. Thus, the wafer carrier 31 approaches two wafer transfer units (TRS) 21a, 21b vertically disposed in the cleaning processing unit 3 to thereby carry a wafer W from the etching processing unit 4 to the cleaning processing unit 3 and oppositely from the cleaning processing unit 3 to the etching processing unit 4.

The primary wafer carrier 32 comprises a cylindrical support 40 rotated by a rotary drive force of a motor not shown, and a wafer carriage 41 disposed movably up and down along the inside of the cylindrical support 40. The wafer carrier 41 is rotated integrally with the cylindrical support 40 on rotation and has three carrying arms 42a, 42b, 42c which are movable forward and backward independently from each other and disposed on multi-stages.

The substrate processing units 22, 23, 24, 25 are arranged in two stages, an upper stage and a lower stage and with the two units on each stage. As shown in FIG. 1, the substrate processing units 22, 23 and the substrate processing units 24, 25 have structures which are symmetrical to the wall 43 bordering the substrate processing units. The structures of the respective substrate processing units 22, 23, 24, 25 are substantially the same except that their structures are symmetrical. Here, the structures will be detailed below with reference to the substrate processing unit 22 as an example.

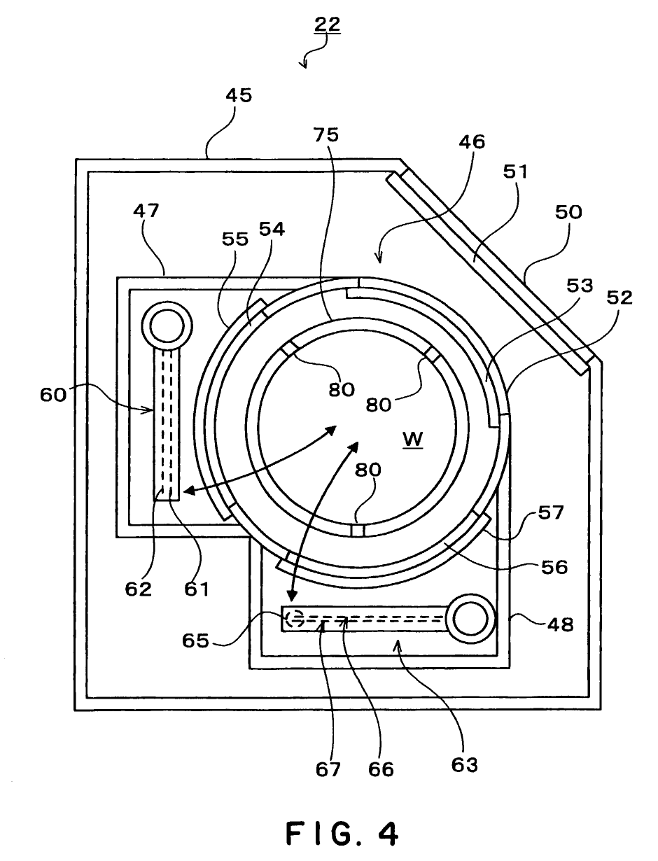

FIG. 4 is a plan view of the substrate processing unit 22. The substrate processing unit 22 includes in a unit chamber 45 a tightly-closed outer chamber 46 for housing a wafer W, a chemical liquid arm stowage 47, and a rinse arm stowage 48. An opening 50 is formed in the unit chamber 45, and a unit chamber mechanical shutter 51 for opening and closing the opening 50 by an opening/closing mechanism not shown is provided. When a wafer W is loaded in and out of the substrate processing unit 22 through the opening 50 by, e.g., the carrying arm 42a, the mechanical shutter 51 for the unit chamber is opened. The mechanical shutter 51 for the unit chamber opens and closes the opening 50 the inside of the unit chamber 45, and even when the unit chamber 45 has a positive internal pressure, an atmosphere inside the unit chamber 45 does not leak outside.

An opening 52 is formed in the outer chamber 46, and a mechanical shutter 53 for the outer chamber opened and closed by a cylinder drive mechanism not shown is provided. When a wafer is loaded in and out of the outer chamber 46 through the opening 52 by, e.g., the carrying arm 42b, the mechanical shutter 53 for the outer chamber is opened. The mechanical shutter 53 for the outer chamber opens and closes the opening 52 from the inside of the outer chamber 46, and even when the outer chamber 46 has an internal positive pressure, an atmosphere in the outer chamber 46 does not leak outside. The chemical liquid stowage 47 has an opening 54, and a shutter 55 for the chemical liquid arm stowage for opening and closing the opening 54 by a drive mechanism not shown. The shutter 55 for the chemical liquid arms to wage is closed when the chemical liquid arm stowage 47 is isolated from an atmosphere of the outer chamber 46. An opening 56 is formed in the rinse arm stowage 48, and a shutter 57 for the rinse arm stowage for opening and closing the opening 56 by a drive mechanism not shown is provided. When the rinse arms to wage 48 is isolated from an atmosphere of the outer chamber 46, the shutter 57 for the rinse arm stowage is closed.

A chemical liquid arm 60 which can eject a chemical liquid for cleaning a wafer w is stowed in the chemical liquid arm stowage 57. The chemical liquid arm 60 can scan a wafer W held by a spin chuck 71 which will be described later at least from the center to the peripheral edge. The chemical liquid arm 60 is retreated in the chemical liquid arm stowage 47 while the processing is not being made. Arm cleaning means not shown is provided in the chemical liquid arm stowage 47 and can clean the chemical liquid arm 60 while the chemical liquid arm 60 is standing by in the chemical liquid arm stowage 47.

In the rinse arm stowage 48, a rinse arm 63 is stowed, which can eject pure water as a processing liquid for the rinse processing, and N₂ gas as an inert gas. The rinse arm 63 is stowed in the outer chamber 46 and can scan a wafer W held by a spin chuck 71 which will be described later from the center to the peripheral edge. The rinse arm 63 is retreated in the rinse arm stowage 48 while the processing is not being made. A two-fluid mixing nozzle 65 for mixing pure water (DIW) with N₂ gas to eject the mixed pure water to a wafer W is provided. The two-fluid mixing nozzle 65 mixes pure water with N₂ gas to pressurize and eject the pure water as a rinse liquid onto the processed surfaces of a wafer W. When the wafer W has hydrophobicity, the two-fluid mixing nozzle 65 ejects, in place of the pure water, IPA mixed pure water as a rinse liquid, which will be described later.

The rinse arm 63 includes pure water supply means 66 for supplying pure water (DIW) to be ejected from the two-fluid mixing nozzle 65, and N₂ gas supply means 67 for supplying N₂ gas. The pure water supply means 66 and the N₂ gas supply means 67 are passed through the rinse arm 63 to supply pure water and N₂ gas to the two-fluid mixing nozzle 65. In the rinse arm stowage 48, arm cleaning means not shown is provided and can clean the rinse arm 64 while the rinse arm 63 is standing by in the rinse arm stowage 48.

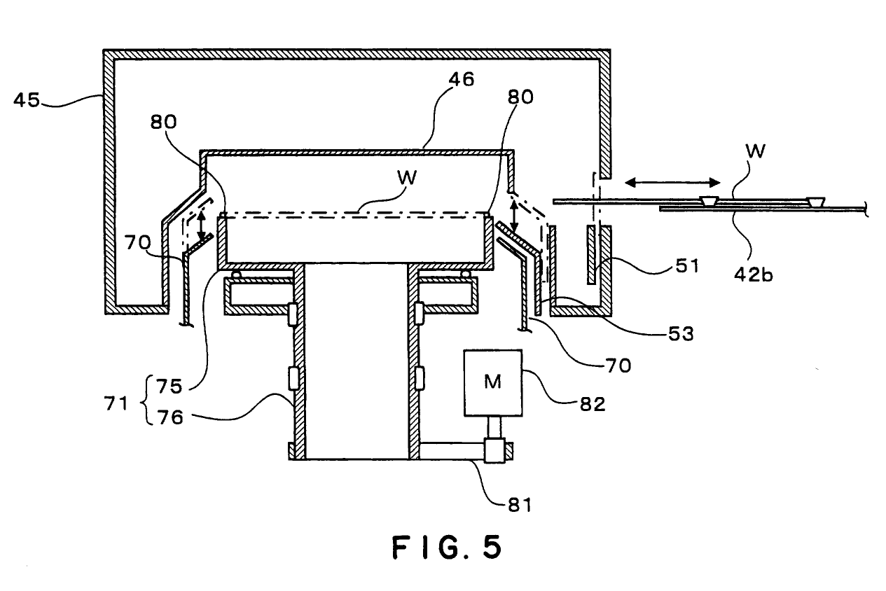

As shown in FIG. 5, in the outer chamber 46 there are provided an inner cup 70 for accommodating a wafer W, and a spin chuck 71 for rotatably supporting the wafer W with the front surface (processed surface), for example, faced upward. The outer chamber 46 has a slant part which corresponds to a height of a wafer W supported by the spin chuck 71, and the slant part surrounds the wafer W. An upper part of the mechanical shutter 53 for the outer chamber form a part of the slant part. When a wafer W is transferred to and from the spin chuck 71, the mechanical shutter 53 for the outer chamber is opened to horizontally move the wafer W.

The spin chuck 71 comprises a chuck body 75 as a support member for supporting a holding member 80 for holding a wafer W, and a rotary cylinder 76 connected to the underside of the chuck body 75. On an upper part of the chuck body 75 at a plurality of positions, there are provided support pins not shown for supporting a wafer W at the peripheral edge of the underside of the wafer W, and support members 80 for holding the wafer W at the peripheral edge. As exemplified in FIG. 5, the holding members 80 are arranged on the circumference of the chuck body 75 at three positions forming central angles of 120°. The three holding members 80 can hold a wafer W at the peripheral edge. Three support pins are provided on the chuck body 75 so as to support the underside of a wafer W at three positions forming central angles of 120°.

A belt 81 is wound on the outer circumferential surface of the rotary cylinder 76, and belt 81 is circumferentially moved by a motor 82 to thereby rotate the whole spin chuck 71. The respective holding members 80 are caused to hold the peripheral edge of a wafer W from the outside as shown in FIG. 4 by a centrifugal force generated when the spin chuck 71 is rotated. While the spin chuck 71 is at a stop, the support pins support a wafer W on the underside, and the holding members 80 hold the wafer W at the peripheral edge while the spin chuck 71 is being rotated.

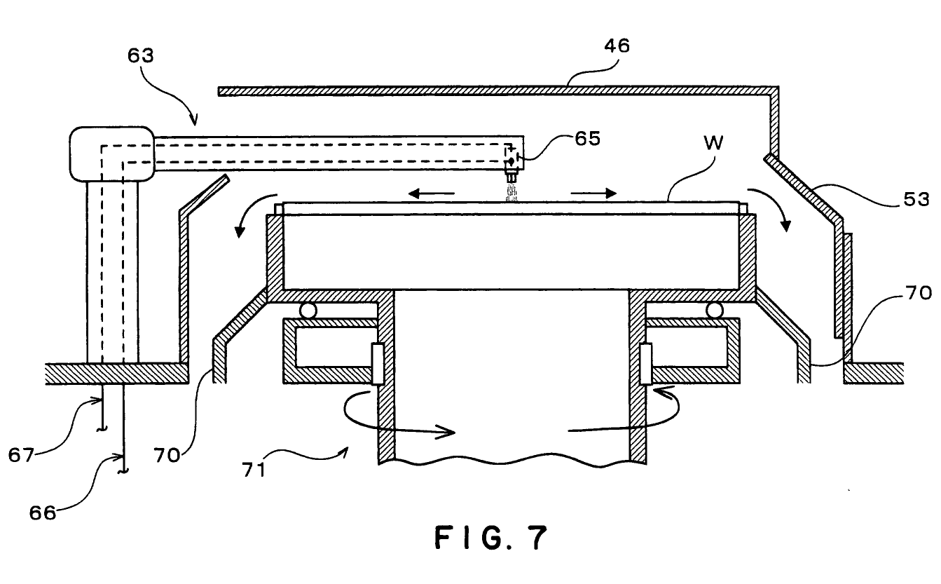

The inner cup 70 is vertically movable down to a position shown in FIG. 7 where the spin chuck 71 is projected upward beyond the upper end of the inner cup 70 to transfer a wafer W and up to a position where—the inner cup 70 surrounds the spin chuck 71 and the wafer W to prevent a cleaning liquid, etc. fed to both surfaces of the wafer W from scattering. The bottom of the inner cup 70 is connected to an inner cup discharge pipe for draining liquid drops in the inner cup 70. The bottom of the outer chamber 46 is connected to an outer chamber discharge pipe not shown for draining liquid drops in the outer chamber 46.

When the inner cup 70 is lowered, the spin chuck 71 and a wafer held by the spin chuck 71 are projected upward beyond the upper end of the inner cup 70. In this state, liquid drops in the outer chamber 46 descend the outside of the inner cup 70 to be drained through the outer chamber discharge pipe. When the inner cup 70 is lifted, the inner cup 70 surrounds the spin chuck 71 and a wafer W to prevent a cleaning liquid, etc. fed to both surfaces of the wafer W from scattering around. In this state, an upper part of the inner cup 70 is brought near the inside wall of the outer chamber 46, and liquid drops in the inner cup 70 are drained through the inner cup discharge pipe.

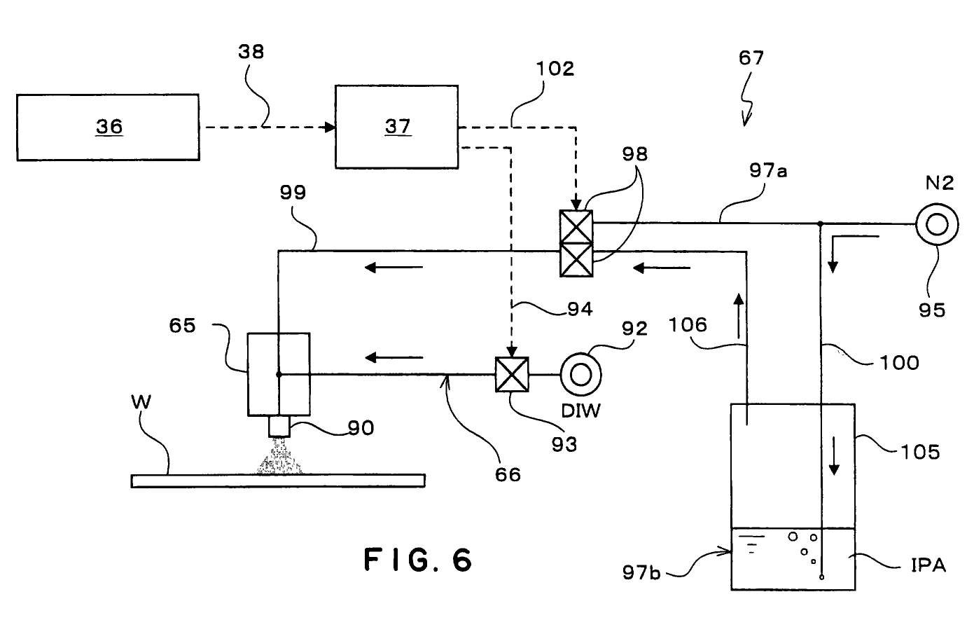

FIG. 6 shows a supply circuit of pure water (DIW) and N₂ gas. An ejection port 90 for ejecting pure water supplied by the pure water supply means 66 is provided in the forward end of the two-fluid mixing nozzle 65. Pure water ejected through the ejection port 90 is supplied from a pure water supply source 92 disposed in the pure water supply means 66. The pure water supply means 66 is passed through the two-fluid nixing nozzle 65 and connected to the ejection port 90. In the two-fluid mixing nozzle 65, N₂ gas supply means 67 is connected to the pure water supply means 66. The opening/closing valve 93 is wired to the control unit 37 by a signal line 94. The control unit 37 supplies control signals to the opening/closing valve 93 to control the opening/closing.

The N₂ gas supply means 67 comprises an N₂ gas supply source 95, a first supply circuit 97a for delivering N₂ gas from the N₂ gas supply source 95, a second supply circuit 97b for mixing the N₂ gas delivered from the N₂ gas supply source 95 with IPA (isopropyl alcohol), a change-over opening/closing valve 98 for changing over the first supply circuit 97a and the second supply circuit 97b for the connection to the supply circuit 99, and a supply circuit 99 for supply—the N₂ gas passed through the change-over opening/closing valve 98 to the pure water supply means 66.

The first supply circuit 97a interconnects the N₂ gas supply source 95 and the change-over opening/closing valve 98, and a pipe 100 is connected to the first supply circuit 97a between the N₂ gas supply source 95 and the change-over opening/closing valve 98. The second supply circuit 97b comprises the pipe 100 branched from the first supply circuit 97a, an IPA tank 105 storing IPA (isopropyl alcohol), which is a fluid for decreasing surface tension of the pure water (DIW), and a pipe 106 interconnecting the IPA tank 105 and the change-over opening/closing valve 98. The pipe 100 is connected to the IPA tank 105 and delivers N₂ gas from the first supply circuit 97a into the IPA tank 105. The downstream end of the pipe 100 is immersed in IPA stored in the IPA tank 105. Accordingly, N₂ gas passed through the pipe 100 is bubbled in the IPA stored in the IPA tank 105. The N₂ gas bubbled in the IPA is a mixed gas mixed with an IPA atmosphere. The IPA tank 105 is a tightly closed container, and in the IPA tank 105, the IPA mixed N₂ gas, which is the N₂ gas mixed with the IPA atmosphere, is stored upper of the IPA stored below. The pipe 106, which is connected to the top of the IPA tank 105, delivers the IPA mixed N₂ gas stored upper in the IPA tank 105 from the IPA tank 105 to the change-over opening/closing valve 98. Thus, the second supply circuit 97b bubbles N₂ gas in IPA to thereby deliver the N₂ gas mixed with IPA. That is, the second supply circuit 97b is IPA mixing means for mixing N₂ gas with IPA.

When the change-over opening/closing valve 98 is changed over to supply the N₂ gas from the first supply circuit 97a, supply of IPA, which lowers surface tension of rinsing processing liquid (N₂ and DIW), is stopped. And, when the change-over opening/closing valve 98 is changed over to feed the N₂ gas from the second supply circuit 97b, supply of IPA, which lowers surface tension of rinsing processing liquid (N₂ and DIW), is stated.

N₂ gas or IPA mixed N₂ gas which has passed through the change-over opening/closing valve 98 is delivered to the pure water supply means 66 through the supply circuit 99. The N₂ gas or the IPA mixed N₂ gas is mixed with pure water here, and the pure water is pressurized by the N₂ gas or the IPA mixed N₂ gas. Accordingly, the pure water can be blasted to a wafer W. When pure water is mixed with the IPA mixed N₂ gas, the IPA is mixed with pure water to be ejected to a wafer W, and the IPA mixed pure water has lower surface tension than the pure water.

In a case that a wafer W has intense phydrophobicity, when pure water stays on the processed surface of the wafer W, a state in which a contact angle φ is large as shown in FIG. 3A, and when drops WD of the pure water evaporate, and the wafer W is dried, water marks tend to be formed. However, even in a case that a wafer W has intense hydrophobicity, a state in which when the IPA mixed pure water, whose surface tension is lower than that of pure water, stays on the processed surface of a wafer W, a contact angle φ is small due to the low surface tension, and when drops of the IPA mixed pure water evaporate, and the wafer W is dried, water marks are not easily formed. Thus, the surface tension of the pure water staying on a wafer is lowered, whereby the generation of water marks can be depressed. On the other hand, in a case that a wafer W has intense phydrophilicity, a state in which when pure water stays on the processed surface of the wafer W, a contact angle φ is small as shown in FIG. 3B, and when drops of the pure water evaporate, and the wafer W is dried, water marks are not easily formed. it is not necessary to mix IPA in pure water to be ejected on wafers W.

The change-over opening/closing valve 98 is connected to the control 37 by a signal line 102. The control unit 37 supplies control signals to the change-over opening/closing valve 98 to change over the first supply circuit 97a and the second supply circuit 97b to be connected to the supply circuit 99. The control unit 3 changes over the change-over opening/closing valve 98, based on a detected result supplied by the detector 36. That is, the control unit 37 supplies control signals to the change-over opening/closing valve 98 so that a wafer loaded in the substrate processing unit 22 is phydrophilic, the change-over opening/closing valve 98 changes over to the first supply circuit 97a, which delivers N₂ gas, and changes over to the second supply circuit 97b, which delivers IPA mixed N₂ gas, when a wafer W is hydrophobic. Thus, the two-fluid mixing nozzle 65 ejects a mixed fluid of pure water and N₂ gas to hydrophilic wafers W and a mixed fluid of pure water, N₂ gas and IPA to phydrophobic wafers W. Hydrophilic wafers W are subjected to rinse processing with pure water. Hydrophobic wafers W are subjected to rinse processing with IPA mixed pure water, and wafers W of low hydrophobicity is rinsed with pure water without IPA mixed, whereby a used amount of IPA can be made smaller.

The structure of the substrate processing unit 22 has been described above. The rest substrate processing units 23, 24, 25 included in the processing system 1 have the same structure as the substrate processing unit 22, and can make cleaning processing on wafers W with chemical liquids and pure water.

The etching processing unit 4 for making etching processing and/or ashing processing comprises a left etching processing unit 110a disposed on the left side as viewed at the wafer carrying unit 30, and a right etching processing unit 110b disposed on the right side as viewed at the wafer carrying unit 30. The left etching processing unit 110a comprises an etching processing apparatus 120a for making etching processing and/or ashing processing, and a load-lock 122a which is a load-in/out unit for loading a wafer W in and out of the etching processing apparatus 120a. The load-lock transfers a wafer W between the etching processing apparatus 120a and the wafer carrying unit 30. The load-lock 122a has two wafer carrying arms 123a, 124a for holding a wafer W. The right etching processing unit 110b has the same structure as the left etching processing unit 110a and can make etching processing and/or ashing processing on a wafer W. That is, the right etching processing unit 110b comprises an etching processing apparatus 120b, a load-lock 122b, and wafer carrying arms 123b, 124b.

Then, steps of processing wafers W by the processing system 1 according to the present embodiment having the above-described structure will be explained. First, the carriers C each housing wafers W, e.g., 25 wafers, which have not been subjected to etching processing are mounted on the in/out port by a carrier robot not shown. The wafers W are taken out of the carriers mounted on the in/out port 6 one by one by, e.g., the lower take-out/setting arm 19a of the wafer carrier 12. The take-out/setting arm 19a mounts the wafer W on the lower wafer transfer unit 20a. Then, the primary wafer carrier 32 receives the wafer W mounted on the wafer transfer unit 20a by, e.g., the lowermost carrying arm 42a, and the cylindrical support 40 is rotated in the θ direction, whereby the carrying arm 42a carries the wafer W the carrying arm 42a has received to the side of the wafer transfer units 21a, 21b. Then, the wafer W is mounted on the lower wafer transfer unit 21a by the carrying arm 42a. Subsequently, the wafer carrier 31 receives by, e.g., the lower take-out/setting arm 39a the wafer W mounted on the wafer transfer unit 21a to carry the wafer W to the left etching processing unit 110a or the right etching processing unit 110b.

The wafer W carried into, e.g., the left etching processing unit 110a is loaded into the etching processing apparatus 120a by, e.g., the wafer carrying arm 123a disposed in the load-lock 122a. In the etching processing apparatus 120a, the etching processing is followed by ashing processing. Then, the wafer W is unloaded out of the etching processing apparatus 120a by, e.g., the upper take-out/setting arm 39b and carried by the wafer carrier 31 to be mounted on the upper wafer transfer unit 21b.

In the upper wafer transfer unit 21b, hydrophibicity of the wafer W is detected by the detector 36. First, a drop D of a detection chemical liquid for detecting the hydrophobicity intensity is dropped on the processed surface of the wafer W mounted on the wafer transfer unit 21b, which has been subjected to the etching processing and/or the etching processing. Then, the detector 36 measures a contact angle φ formed by the drop D, detects the hydrophobicity intensity based on a measured contact angle φ and supplies detected signals to the control unit 37.

The wafer W, whose contact angle φ has been measured at the processed surface, is held by, e.g., the carrying arm 42b of the primary wafer carrier 32 to be loaded from the wafer transfer unit 21b suitably into the substrate processing unit 22, 23, 24, 25. Then, prescribed cleaning processing including rinse processing including cleaning for particle removal by the use of chemical liquid cleaning and two-fluid mixing nozzle 65, and drying processing is made to thereby remove contaminants, such as polymers, particles, etc. staying on the wafer W. Here, the control unit 37 supplies control signals to the change-over opening/closing valve 98, based on the hydrophobicity intensity detected in the wafer transfer unit 21b, and the mixed fluid to be ejected through the two-fluid mixing nozzle 65 is changed over. The wafer W which has completed prescribed cleaning processing steps is unloaded out of the substrate processing unit 22, 23, 24, 25 by, e.g., the carrying arm 42c of the primary carrier 32.

The wafer W unloaded out of the substrate processing unit 22, 23, 24, 25, after being carried by the rotation of the cylindrical support 40 of the primary wafer carrier 32, is loaded into one of the five baking units disposed inside the heating/cooling unit 26 by the carrying arm 42c. The wafer W which has completed the baking processing in the baking unit is suitably unloaded out of the baking unit by, e.g., the carrying arm 42c of the primary wafer carrier 32 and carried to the transfer unit 20a, 20b by the rotation of the cylindrical support 40 to be mounted on the upper wafer transfer unit 20b by the upper carrying arm 42c.

As described above, the etching processing step of the wafers Win the etching processing unit 4 is followed the ashing processing step, and then the chemical liquid processing and the rinse processing follow in the stated order in the respective substrate processing units 22, 23, 24, 25 of the cleaning processing unit 3. Then, the drying processing for drying the wafers W follows, and further the baking processing step follows in the respective baking units.

Subsequently, the wafer carrier 12 receives the wafers W from the upper wafer transfer unit 20b by, e.g., the upper take-out/setting arm 19b to carry the wafers W to the line width measuring unit 8. The line width measuring unit 8 measures line widths of a pattern applied to the processed surfaces of the wafers W which have completed the processing in the etching processing unit 4 and the cleaning processing unit 3. Then, the wafers W are unloaded out of the line width measuring unit 8 by the wafer carrier 12 to the in/out port 6 to be housed again in the carriers C.

Here, the cleaning processing will be explained with reference to the cleaning processing in the substrate processing unit 22. As shown in FIG. 5, the mechanical shutter 51 for the unit chamber of the substrate processing unit 22 is opened, and the outer chamber mechanical shutter 53 for the outer chamber 46 is opened. Then, the carrying arm 42b holding a wafer W is advanced into the substrate processing unit 22. The inner cup 70 has been lowered to relatively project the chuck body 75 upward. The shutter 55 for the chemical liquid arm stowage and the shutter 57 for the rinse arm stowage are closed.

The primary wafer carrier 32 moves the carrying arm 42b horizontally to transfer the wafer W to the spin chuck 71. The spin chuck 71 supports the wafer W with the surface (processed surface) of the wafer W for a semiconductor device to be fabricated on faced upward by the support pins not shown. After the carrying arm 42b has transferred the wafer W to the spin chuck 71, the carrying arm 42b is retreated out of the outer chamber 46 and to the outside of the mechanical shutter 51 for the unit chamber. When the carrying arm 42b has been retreated, the mechanical shutter 51 for the unit chamber and the outer chamber mechanical shutter 53 for the outer chamber 46 are closed. The inner cup 70 is lifted to surround the chuck body 75 and the wafer W.

Next, the spin chuck 71 is started to rotate to hold the wafer W on rotation. The shutter 55 for the chemical liquid arm stowage is opened, and the chemical liquid arm 60 is swung to above the wafer W. The chemical liquid arm 60 scans the wafer W held and rotated by the spin chuck 71 at least from the center to the peripheral edge to supply a chemical liquid. Thus, the chemical liquid can be diffused all over the surface of the wafer W. The chemical liquid to be thus supplied is adjusted to a prescribed temperature by a temperature adjuster, e.g., a heater or others. The chemical liquid which has flowed around the wafer W flows into the inner cup 70 and further drained out of the outer chamber 46 through the inner cup discharge pipe not shown. When the cleaning with the chemical liquid is completed, the chemical liquid arm 60 is moved into the chemical liquid arm stowage 47, and the shutter 55 for the chemical arms to wage is closed. With the shutter 55 for the chemical liquid arm stowage closed, the chemical liquid arm stowage 47 is kept tightly closed to thereby prevent a chemical liquid atmosphere generated from the chemical liquid arm 60 from contaminating the wafer W and the rinse arm 63. Then, the inner cup 70 is lowered as shown in FIG. 7 to surround the chuck body 75 and the wafer W by the outer chamber 46.

Next, the shutter 57 for the rinse arm stowage is opened, and the rinse arm 63 is moved out of the rinse arm stowage 48 into the outer chamber 46 and swung to above the wafer W. The control unit 37 supplies control signals to open the opening/close valve 98 of the pure water supply means 66 to deliver pure water to the two-fluid mixing nozzle 65. On the other hand, the control unit 37 judges whether the wafer W is hydrophobic or hydrophilic, based on a detection result given by the detector 36 before the wafer W is loaded into the substrate processing unit 22 and supplies control signals based on the judgement to the change-over opening/closing valve 98 through the signal line 102. That is, the change-over of the change-over opening/closing valve 98 is controlled, whereby the two-fluid mixing nozzle 65 ejects a mixed fluid of pure water and N₂ gas when the wafer W is hydrophilic, and when the wafer W is hydrophobic, ejects a mixed fluid of pure water, N₂ gas and IPA.

When the wafer W is hydrophilic, the change-over opening/closing valve 98 is switched to the first supply circuit 97a to deliver N₂ gas from the N₂ gas supply source 95 and supply the N₂ gas to the two-fluid mixing nozzle 65. The N₂ gas passes through the supply circuit 99 and flows into the pure water supply means 66 at the interconnection between the supply circuit 99 and the pure water supply means 66. The pure water is pressurized here by the N₂ gas. The N₂ gas and the pressurized pure water are ejected from the ejection port 90, and the pure water is fed to the hydrophilic wafer W to rinse the wafer W.

On the other hand, when the wafer W is hydrophobic, the change-over opening/closing valve 98 is switched to the second supply circuit 97b to deliver IPA mixed N₂ gas stored upper in the IPA tank 105 to the two-fluid mixing nozzle 65. The IPA mixed N₂ gas passes through the supply circuit 99 and flows into the pure water supply means 66 at the interconnection between the supply circuit 99 and the pure water supply means 66. The pure water is pressurized here by the IPA mixed N₂ gas while being mixed with the IPA of the IPA mixed N₂ gas to be IPA mixed pure water. Thus, The IPA mixed N₂ gas and the pressurized IPA mixed pure water are ejected from the ejection port 90 to supply the IPA mixed pure water to the hydrophobic wafer W and rinse the wafer W.

The rinse arm 63 scans the wafer W at least from the center to the peripheral edge to eject from the two-fluid mixing nozzle 65 a mixed fluid of pure water, N₂ gas and IPA, or a mixed fluid of pure water and N₂ gas. As shown in FIG. 7, the mixed fluid which has flowed around the wafer W flows into the outer chamber 46 and further discharged out of the outer chamber 46 through the outer chamber discharge pipe not shown. When the rinse with the pure water or with the IPA mixed pure water, the opening/closing valve 93 and the change-over opening/closing valve 98 are closed to stop the supply of the mixed fluid. The rinse arm 63 is moved into the rinse arm stowage 48, and the shutter 57 for the rinse arm stowage is closed.

After the rinse processing, the wafer W is rotated for spin drying at higher speed (e.g., about 1550 rpm) than for the rinse processing. At this time, N₂ gas may be fed to the upper surface of the wafer by the rinse arm 63. Drops of the pure water or the IPA mixed pure water are scattered from the wafer W by the centrifugal force into the outer chamber 46 and further discharged out of the outer chamber 46 through the outer chamber discharge pipe.

After the drying processing, the wafer W is unloaded out of the substrate processing unit 22. The mechanical shutter 53 for the unit chamber and the mechanical shutter 51 for the outer chamber are opened, and the carrying arm 42b, for example, is advanced into the substrate processing apparatus to support the wafer W at the underside. Then, the carrying arm 42b detaches the wafer W from the support pins of the spin chuck 71 to receive the wafer W and is retreated out of the substrate processing unit 22.

In this substrate processing unit 22, IPA for lowering the surface tension of pure water is mixed in the pure water to thereby feed wafer W IPA mixed pure water whose surface tension is lower than the pure water, whereby the generation of water marks can be depressed. When the wafer W is hydrophilic, IPA is not mixed in pure water, which makes a used amount of IPA smaller.

One preferred embodiment of the present invention has been explained above. However, the present invention is not limited to the above-described embodiment and can be suitably modified. For example, the substrates of the present invention is not essentially semiconductor wafers and can be glasses for LCD substrates, CD substrates, printed circuit boards, ceramic substrates, etc.

The present invention is not limited to the substrate processing apparatus to which chemical liquids are supplied. The present invention can be substrate processing apparatuses in which processing other than cleaning is made on substrates with various processing liquids other than chemical liquids, and then rinse processing and rinse processing for removing particles, with pure water. For example, in a case that etching processing alone is made in the etching processing unit 4, it is possible that resist removing processing with a chemical liquid for resist removing processing is made in the substrate processing unit 22, and then cleaning processing is made with the chemical liquid and the rinse liquid explained in the above-described embodiment. The substrate processing apparatus can clean wafers W with scrubbers, such as brushes, sponges, etc. The processing for substrates can be cleaning wafers W by the two-fluid mixing nozzle 65, e.g., cleaning for removing particles staying on the wafers W.

The detector 36 may be disposed on an upper part of the outer chamber 46 in the substrate processing unit 22. In this case, the detection step for detecting hydrophobicity of wafers W can be performed before the rinse processing step. That is, even in a case that the hydrophobiity of wafers W changes depending on a kind of the chemical liquid, the hydrophobicity of the wafers W an be detected without unloading the wafers W out of the substrate processing unit 22. For example, when wafers W are chemically processed with HF (diluted hydrogen fluoride), the wafers W become hydrophobic, and become hydrophilic when processed with APM (a mixed solution of ammonium and aqueous solution of hydrogen peroxide) or SPM (a mixed solution of condensed sulfuric acid and aqueous solution of hydrogen peroxide). In these cases as well, the rinse liquid to be fed to the wafers W can be changed to pure water or IPA mixed pure water, depending on a detected result.

Means for judging the hydrophobicity of wafers W is not limited to the detector 36 for metering contact angles φ and can be other various means. For example, in a case that a film formed on the processed surfaces of wafers W have been confirmed in advance, a rinse liquid can be changed in accordance with a kind of the film. For example, polysilicon film, which is hydrophobic, can be processed with IPA mixed pure water. Silicon oxide film, which is hydrophilic, can be processed with pure water. The mixture of IPA can be controlled depending on a kind of a chemical liquid used in the chemical liquid processing step before the rinse processing step. For example, in a case that wafers W have been processed with the above-described HF, the processed surfaces of the wafers W are hydrophobic and are rinsed with IPA mixed pure water. In cases that wafers W are processed with the above-described APM and SPM, the processed surfaces of the wafers W are hydrophilic, and the change-over is done for the rinse processing with pure water.

Furthermore, the substrate processing apparatus may comprise input means for inputting an information of whether the substrate is hydrophobic or hydrophilic. The control unit can control the mixing ratio of the processing liquid (e.g. DIW) and the fluid (e.g. IPA) for lowering surface tension of the processing liquid, or start/stop of mixing the fluid into the processing liquid, based on the information inputted by the input means.

In FIG. 6, it is possible that the change-over opening/closing valve 98 is a mixing valve so that N₂ gas delivered by the first supply circuit 97a and IPA mixed N₂ gas delivered by the second supply circuit 97b can be mixed with each other. In this case, the mixture of IPA can be controlled by the mixing valve, based on a detected result of the detector 36. That is, as a measured contact angle φ is larger, and the hydrophobicity is higher, a larger amount of IPA mixed N₂ gas delivered by the second supply circuit 97b is mixed to thereby mix a larger amount of IPA in pure water, whereby IPA mixed pure wager can have a decreased surface tension. Oppositely, in a case that a contact angle φ is small, and the hydrophobicity is low, IPA is mixed in a decreased amount, whereby IPA can be saved. For example, an amount of IPA to be mixed in N₂ gas can be controlled by controlling a rate of N₂ gas to be delivered to the IPA tank 105 through the pipe 100 when N₂ gas is bubbled in IPA, whereby a amount of IPA to be mixed in N₂ gas can be controlled. Furthermore, a mixed fluid of pure water and N₂ gas is supplied with a temperature of N₂ gas adjusted by a temperature adjusting function (or a temperature adjuster), N₂ gas having temperature adjusted to, e.g., 50-200° C. In this case, pure water staying on wafers W can be dried at higher speed, whereby he generation of water marks can be more effectively depressed.

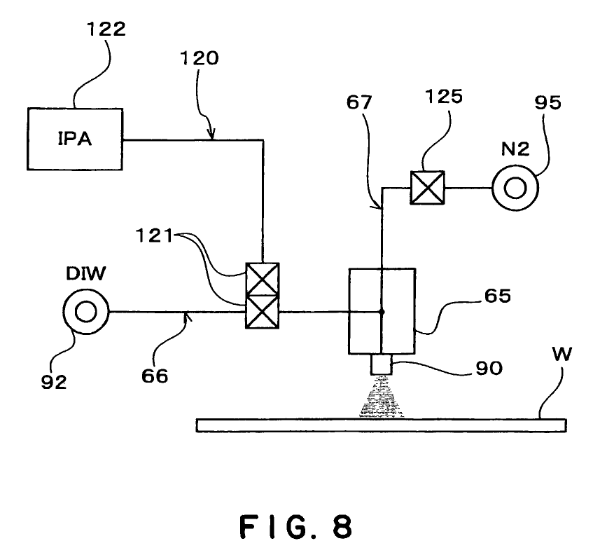

As shown in FIG. 8, IPA mixing means 120 for mixing IPA with pure water may be disposed in the pure water supply means 66. In FIG. 8, the IPA mixing means 120 is connected to the pure water supply means 66 at a change-over mixing valve 121. The IPA supply means 120 includes an IPA supply tank 122 as a supply source of IPA. The change-over mixing valve 121 is wired to the control unit 37 by a signal line not shown. That is, the IPA supply means 120 and the change-over mixing valve 121 are IPA mixing means for mixing IPA with pure water. An opening/closing valve 125 wired to the control unit 37 by a signal line is inserted in the N₂ gas supply means 67 including the N₂ gas supply source 95. In this case as well, pure water, IPA and N₂ gas can be mixed inside the two-fluid mixing nozzle 65.

In FIG. 8, the change-over mixing valve 121 for mixing IPA with pure water can be adjusting means which can adjust concentrations of IPA of IPA mixed pure water. In this case, the mixture of IPA can be controlled based on a detection result of the detector 36. That is, as a measured contact angle φ is larger, and the hydrophobicity is higher, IPA is mixed in an increased mixing amount to make the surface tension of the IPA mixed pure water smaller. When the hydrophobicity of wafers W is very high, pure water is not mixed, but IPA alone is supplied to the two-fluid mixing nozzle 65, and the IPA and N₂ gas mixed and ejected. That is, a mixing ratio of the fluid for lowering surface tension of the processing liquid into the processing liquid ranges from 0% to 100%. Thus wafers W may be rinsed with IPA.

According to the substrate processing apparatus and substrate processing method of the present invention, the generation of water marks can be depressed by supplying IPA mixed pure water, which has lower surface tension than pure water. This permits the fluid mixing nozzle to be used in processing hydrophobic wafers. When wafers are hydrophilic, IPA is not mixed with pure water, which can makes a used amount of IPA small. An amount of IPA to be mixed with pure water can be adjusted in accordance with hydrophobicity intensity of wafers, which can make a used amount of IPA small.

What is claimed is:

1. A substrate processing apparatus comprising processing liquid supply pipe for supplying a processing liquid, inert gas supply pipe for supplying an inert gas, and a fluid mixing nozzle for mixing and ejecting the processing liquid with the inert gas, so as to process a substrate with the processing liquid,
the inert gas supply pipe or the processing liquid supply pipe comprising fluid mixer for mixing a fluid for lowering surface tension of the processing liquid into the inert gas or the processing liquid respectively.

2. The substrate processing apparatus according to claim 1, comprising a control unit for controlling a mixing ratio of the processing liquid and the fluid for lowering surface tension of the processing liquid, or the start/stop of mixing the fluid for lowering surface tension of the processing liquid into the inert gas or the processing liquid.

3. The substrate processing apparatus according to claim 2, comprising a chemical liquid supply nozzle for supply a chemical liquid to the substrate.

4. The substrate processing apparatus according to claim 3, wherein
the control unit controls a mixing ratio of the processing liquid and the fluid for lowering surface tension of the processing liquid, or the start/stop of mixing the fluid for lowering surface tension of the processing liquid into the inert gas or the processing liquid, based on a kind of the chemical liquid.

5. The substrate processing apparatus according to claim 2, comprising a detector for detecting whether the substrate is hydrophobic or hydrophilic.

6. The substrate processing apparatus according to claim 5, wherein
the detector drops a drop of a detection chemical liquid onto the substrate and measures a contact angle of the drop to the surface of the substrate.

7. The substrate processing apparatus according to claim 5, wherein
the control unit controls a mixing ratio of the processing liquid and the fluid for lowering surface tension of the processing liquid, or the start/stop of mixing the fluid for lowering surface tension of the processing liquid into the inert gas or the processing liquid, based on a detection result of the detector.

8. The substrate processing apparatus according to claim 2, wherein
the control unit gets information of whether the substrate is hydrophobic or hydrophilic and perform control so as to supply the processing liquid and the inert gas onto the substrate when the substrate is hydrophilic and supply the processing liquid, the inert gas and the fluid for lowering surface tension of the processing liquid onto the substrate when the substrate is hydrophobic.

9. The substrate processing apparatus according to claim 2, comprising input means for inputting an information of whether the substrate is hydrophobic or hydrophilic, whereby
the control unit gets the information from the input means and controls a mixing ratio of the processing liquid and the fluid for lowering surface tension of the processing liquid, or the start/stop of mixing the fluid for lowering surface tension of the processing liquid into the inert gas or the processing liquid.

10. The substrate processing apparatus according to claim 2, wherein
the control unit controls a mixing ratio of the processing liquid and the fluid for lowering surface tension of the processing liquid, or the start/stop of mixing the fluid for lowering surface tension of the processing liquid into the inert gas or the processing liquid, based on a kind of a film of the substrate.

11. The substrate processing apparatus according to claim 2, wherein
the inert gas supply pipe comprises an temperature adjuster for adjusting a temperature of the inert gas.
